(19) United States
(12) Patent Application Publication
(10) Pub. No.: US 2026/0284624 A1
(43) Pub. Date: Sep. 24, 2026

(54) POROUS FLUIDIZATION DEVICE AND SYSTEMS RELATED THERETO

(71) Applicant: ExxonMobil Technology and Engineering Company, Spring, TX (US)

(72) Inventors: Christopher J. FOWLER, Houston, TX (US); Patrick L. YODER, Montgomery, TX (US); Aaron M. SCHLETT, Conroe, TX (US)

(73) Assignee: ExxonMobil Technology and Engineering Company, Spring, TX (US)

(21) Appl. No.: 19/473,781

(22) PCT Filed: Apr. 10, 2024
(86) PCT No.: PCT/US2024/023828

§ 371 Date: Oct. 8, 2025

Related U.S. Application Data
(60) Provisional application No. 63/496,327, filed on Apr. 14, 2023.

(51) Int. Cl. B01J 8/18; B01J 8/24; C10G 11/18

(52) U.S. Cl. CPC B01J 8/1818; B01J 8/24; C10G 11/18; B01J 2208/00902

(57) ABSTRACT

A refractory-lined equipment includes a vessel that defines an interior and houses a bed of particles, a refractory material secured to an inner wall of the interior, a nozzle assembly coupled to and penetrating a sidewall of the vessel and extending into the interior. The nozzle assembly includes a support structure, and a refractory fluidization nozzle received within the support structure and including a dense outer layer that defines an interior flow passage, and a porous inner layer positioned within the interior flow passage. A fluid circulated through the porous inner layer and is discharged into the vessel as bubbles that fluidize the bed of particles, wherein the dense outer layer is composed of a refractory material that is impermeable to the fluid, and the porous inner layer is composed of a refractory material that is permeable to the fluid.

### FIELD OF INVENTION

The present disclosure relates to porous fluidization devices and, more particularly, to porous devices, such as nozzles, made of a variety of materials for use in the oil and gas refining and petrochemical industry, and systems related thereto.

### BACKGROUND

The fluidization of particulate solids using circulating fluidized-bed (CFB) processes is prevalent in various aspects of the oil and gas refining and petrochemical industry (collectively “oil and gas industry”). In CFB processes, an upward-flowing fluid (e.g., a gas and/or a liquid, such as an atomized liquid) that imposes a high enough drag force to overcome the downward force of gravity is used to fluidize particulates, thus forming a CFB. CFB processes offer a number of advantages, including highly efficient heat transfer, the ability to affect movement of solids like a liquid, and the capability of processing materials with a wide particle size distribution.

CFB processes may be carried out in various oil and gas industry equipment, such as reactor vessels, furnace vessels, regenerator vessels, transfer lines (pipes), and the like. For example, in a fluidized catalytic cracking process, the cracking reaction is realized by utilizing CFBs in a reactor vessel and burner (regenerator) to provide efficient heat transfer and relatively quick coking on a large surface area of small regenerator particles circulating between the reactor and the regenerator. Other such processes include, but are not limited to, drying, cooling, and pneumatic transport of solid particulates (e.g., powders); coating of equipment (e.g., chemical vapor deposition coating); combustion or gasification of coal or biomass; and the like.

Often, the equipment (e.g., vessels and/or transfer lines) employing CFB processes are lined with erosion and heat resistant refractory materials. One or more nozzles (fluidization nozzles) penetrate the walls of such equipment for the purpose of injecting a fluidizing gas or liquid. Conventionally, fluidization nozzles comprise metal piping having a single nozzle or a combination of nozzles, each exhibiting a set or predetermined orifice diameter, and used to control pressure drop and inject a gas or liquid into an oil and gas process. These conventional metal piping fluidization nozzles may be provided with mechanical and/or thermal insulation reinforcement or may be connected to a header in series with other fluidization nozzles to permit wider fluidization coverage.

Conventional metal piping fluidization nozzles, however, suffer from temperature, corrosion, and erosion limitations. For example, the use of conventional metal piping fluidization nozzles at the high temperature process conditions typically employed during applicable oil and gas processes can result in material expansion and contraction, thereby leading to thermomechanical damage causing cracking, sintering and spalling of non-metal components, and reduction of gas/liquid injection velocity. Moreover, compositional process conditions can result in corrosion (e.g., due to aggressive environments, chemicals, reduction/oxidation conditions, and the like), and contact with the solids intended to be fluidized can also result in erosion. Such limitations can result in undesirable reliability and costly repairs. Moreover, conventional metal piping fluidization nozzles often further suffer from relatively poor fluidization capacity, which is compensated for by increasing the number of nozzles and/or the pressure through the nozzles, both of which increases costs and result in undesirable reliability and servicing requirements.

With respect to the aforementioned considerations, the present disclosure provides refractory fluidization nozzles and systems related thereto for improved fluidization reliability and efficacy, without being negatively impacted or otherwise damaged by oil and gas process conditions.

### SUMMARY OF INVENTION

Various details of the present disclosure are hereinafter summarized to provide a basic understanding. This summary is not an extensive overview of the disclosure and is neither intended to identify certain elements of the disclosure, nor to delineate the scope thereof. Rather, the primary purpose of this summary is to present some concepts of the disclosure in a simplified form prior to the more detailed description that is presented hereinafter.

In one or more embodiments, a refractory-lined equipment is disclosed and includes a vessel that defines an interior and houses a bed of particles, a refractory material secured to an inner wall of the interior, and a nozzle assembly coupled to and penetrating a sidewall of the vessel and extending into the interior. The nozzle assembly includes a support structure, and a refractory fluidization nozzle received within the support structure and including a dense outer layer that defines an interior flow passage, and a porous inner layer positioned within the interior flow passage. The equipment further includes a fluid circulated through the porous inner layer and discharged into the vessel as bubbles that fluidize the bed of particles, wherein the dense outer layer is composed of a refractory material that is impermeable to the fluid, and the porous inner layer is composed of a refractory material that is permeable to the fluid.

In one or more additional embodiments, a method is disclosed and includes providing a vessel that defines an interior and houses a bed of particles and includes a refractory material secured to an inner wall of the interior, and a nozzle assembly coupled to and penetrating a sidewall of the vessel and extending into the interior. The nozzle assembly includes a support structure, and a refractory fluidization nozzle received within the support structure and including a dense outer layer that defines an interior flow passage, and a porous inner layer positioned within the interior flow passage. The method may further include circulating a fluid through the porous inner layer and discharging the fluid from the porous inner layer and into the interior as bubbles, and fluidizing the bed of particles with the bubbles, wherein the dense outer layer is composed of a refractory material that is impermeable to the fluid, and the porous inner layer is composed of a refractory material that is permeable to the fluid.

In one or more additional embodiments, a nozzle assembly for fluidizing solid particulates is disclosed and includes a support structure, and a refractory fluidization nozzle received within the support structure and including a dense outer layer that defines an interior flow passage, and a porous inner layer positioned within the interior flow passage, wherein the dense outer layer is composed of a refractory material that is impermeable to fluids, and the porous inner layer is composed of a refractory material that is permeable to fluids.

These and other features and attributes of the disclosed apparatuses and systems of the present disclosure and their advantageous applications and/or uses will be apparent from the detailed description which follows.

### BRIEF DESCRIPTION OF THE DRAWINGS

To assist those of ordinary skill in the relevant art in making and using the subject matter hereof, reference is made to the appended drawings. The following figures are included to illustrate certain aspects of the disclosure, and should not be viewed as exclusive configurations. The subject matter disclosed is capable of considerable modifications, alterations, combinations, and equivalents in form and function, as will occur to those skilled in the art and having the benefit of this disclosure.

FIG. 1 is a partial schematic side view of example refractory-lined equipment that may incorporate the principles of the present disclosure.

FIG. 2 is an enlarged cross-sectional side view of an example nozzle assembly, according to one or more embodiments of the present disclosure.

### DETAILED DESCRIPTION

This application relates to porous fluidization devices and, more particularly, to porous devices, such as nozzles, made of a variety of materials for use in the oil and gas refining and petrochemical industry, and systems related thereto.

The embodiments discussed herein describe refractory fluidization nozzles (and assemblies that incorporate the fluidization nozzles) that advantageously allow reliable and effective fluidization of particulates during an oil and gas refining or other petrochemical processes (collectively referred to herein as an “oil and gas process”), without susceptibility to damage by means of contact with the process or chemical conditions of the oil and gas process. In one or more aspects, the applicable oil and gas process is carried out in refractory-lined equipment designed for thermal insulation, corrosion protection, and/or solid particulate erosion. The refractory fluidization nozzles of the present disclosure are configured to penetrate a wall of the refractory-lined equipment (or other oil and gas equipment), and can be located at any location depending on the configuration/geometry of the particular equipment, without limitation.

It is to be appreciated that while the following disclosure is described with reference to refractory-lined equipment, any oil and gas equipment (e.g., non-refractory-lined) requiring fluidization of an oil and gas process may be equipped with the refractory fluidization nozzles of the present disclosure.

Illustrative aspects of the refractory fluidization nozzles described herein include, but are not limited to, a two-layer configuration in which a dense refractory material surrounds (encases) a porous refractory material, thus resulting in a dense outer layer and a porous inner layer. The refractory material and the small injection bubble size formed using the porous inner layer, as described below, allows for increased reliability and service life as compared to conventional metal piping fluidization nozzles, thereby reducing overall costs associated with fluidization in oil and gas processes. In one or more aspects of the present disclosure, the dense outer layer refractory material and the porous inner layer refractory material each comprise a ceramic material.

The porous refractory material is an engineered, erosion-resistant refractory material, which may comprise random interconnected pores, directional slots (along the longitudinal axis of the nozzle), or a combination thereof. The random pores and/or the directional slots can each provide a path through which a fluid (i.e., a gas and/or a liquid) can flow for fluidization of particulates within equipment for use in an oil and gas process. In embodiments that include random interconnected pores, the fluid flow through the porous refractory material may follow a tortuous pathway, including random, sinuous, and spiraled (e.g., swirled) passages, and depending on the particular design of the porous refractory material. It is to be appreciated that while the present disclosure discusses the refractory fluidization nozzles with reference to injecting a fluid into an oil and gas process, other substances may be injected alone or in combination with the fluid, such as a chemical or other substances that are capable of facilitating fluidization or complimenting the fluidization process.

Engineering the porous refractory material advantageously allows for effective fluidization mixing by controlling the injection bubble size (e.g., the size of the bubbles exiting the nozzle), the flow, and the distribution (e.g., random and/or directional) of the fluid. For example, the porous inner refractory material is preferably engineered to discharge the fluid with an average bubble size diameter in the range of about 10 to about 100 μm, and encompassing any value and subset therebetween, which is significantly smaller than a conventional fluidization nozzle producing an average particle size diameter of about 1 to about 100 cm. In some embodiments, the porous inner refractory material may be engineered to discharge the fluid with an average bubble size diameter in the range of about 1000 to about 1500 μm, and encompassing any value and subset therebetween. By reducing the injection bubble size of the fluid and further increasing the number of injection points (i.e., a greater number of areas that smaller bubbles escape from the porous inner layer), enhanced lift can be realized to more efficiently cause particulates within oil and gas process equipment to behave as a flowing fluid. Moreover, advantageously, the amount of the fluid required for fluidization can be reduced and the small pores or slots in the inner layer of the fluidization nozzle prevents processing compositions from interfering with (clogging) the various fluid paths.

The refractory fluidization nozzles described herein are arranged to penetrate the wall of refractory-lined equipment at a variety of locations and as part of a fluidization nozzle assembly. The fluidization nozzle assembly includes the refractory fluidization nozzle and may further include a support structure that surrounds the refractory fluidization nozzle. The support structure may comprise, for example, a metal sleeve, pipe, or can, or may otherwise comprise any type of anchoring mechanism capable of securing the refractory fluidization nozzle to a vessel wall or the like. The support structure may be configured to encase (surround) the refractory fluidization nozzle and may be secured thereto via an interference fit or the like, which allows for compression and retraction of refractory-lined equipment during an oil and gas process.

In at least one embodiment, it is contemplated herein that the refractory fluidization nozzle be selectively installed and removed from the support structure. In some embodiments, for example, the support structure of the fluidization nozzle assembly may comprise an orifice defined through the wall of the refractory-lined equipment, and the refractory fluidization nozzle may be removably coupled to the orifice. In other embodiments, however, the support structure may comprise a sleeve or can that surrounds the refractory fluidization nozzle and is configured to be secured to the orifice in the wall of the refractory-lined equipment. In such embodiments, the support structure may form a permanent attachment to the wall of the refractory-lined equipment, but could alternatively also be removable. Moreover, in such embodiments, the refractory fluidization nozzle may be removable from the sleeve or can. Accordingly, in various aspects, the present disclosure further provides an assembly for installation and removal of the refractory fluidization nozzles described herein.

### Definitions

As used herein, the terms “ceramic refractory fluidization nozzle,” “refractory fluidization nozzle,” “fluidization nozzle,” and “nozzle,” and grammatical variants thereof, may be used interchangeably herein and refer to the refractory fluidization nozzles of the present disclosure comprising a dense outer layer of refractory material and a porous inner layer of refractory material. Conventional (or traditional) fluidization nozzles will be referred to as such for clarity.

As used herein, the term “dense outer layer,” with reference to a component part of the refractory fluidization nozzles of the present disclosure, includes, but is not limited to, an outer portion of a refractory fluidization nozzle that encases a porous inner layer of the refractory fluidization nozzle. The dense outer layer is composed of a refractory material that does not permit fluid (i.e., a gas or a liquid) diffusion therethrough. That is, the dense outer layer is composed of a refractory material that is a substantially or entirely impermeable solid.

As used herein, the term “porous inner layer,” with reference to the refractory fluidization nozzles of the present disclosure, includes, but is not limited to, an inner portion of a refractory fluidization nozzle that is encased by a dense outer layer of the refractory fluidization nozzle. The porous inner layer is composed of a refractory material that permits fluid (i.e., a gas or a liquid) diffusion therethrough. That is, the porous inner layer is composed of a permeable refractory material.

As used herein, the terms “circulating fluidized bed,” “fluidized bed,” and “CFB,” and grammatical variants thereof, are used interchangeably herein and refer to a collection of solid particulates suspended and kept in motion by a flow and diffusion of a fluid (i.e., a gas or a liquid, such as an atomized liquid) through the collection of solid particulates.

As used herein, the terms “oil and gas industry process” and “oil and gas processes,” and grammatical variants thereof, are used interchangeably herein and refer to any process performed during refining or petrochemical operation that incorporates the use of a CFB. Examples of such oil and gas processes include, but are not limited to, catalytic cracking; drying, cooling, and pneumatic transport of solid particulates (e.g., powders); coating of equipment (e.g., chemical vapor deposition coating); combustion or gasification of coal or biomass; and the like.

As used herein, the term “refractory material,” and grammatical variants thereof, refers to a material that is resistant to decomposition by temperature (e.g., retaining strength and form at high temperature), pressure, or chemical attack. Refractory materials are generally composed primarily of oxides, carbides, and nitrides with other elements, such as, but not limited to, silicon, aluminum, magnesium, calcium, boron, chromium, and zirconium. The refractory material used in one or more of the presently disclosed embodiments may comprise a ceramic.

### Refractory Nozzles and Systems Related Thereto

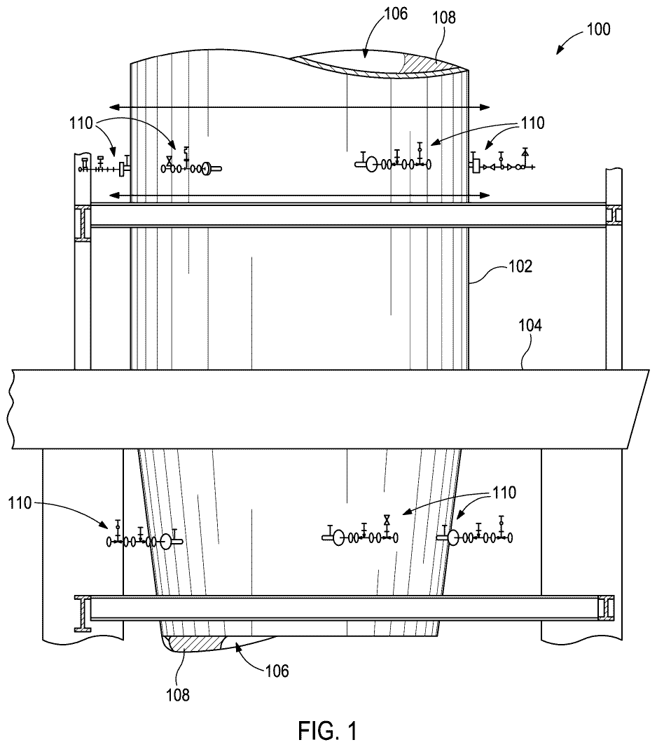

FIG. 1 is a schematic partial side view of an example refractory-lined equipment 100 that may incorporate the principles of the present disclosure. In the illustrated embodiment, the refractory-lined equipment 100 comprises a reactor vessel, such as for use in chemical or catalytic conversion of hydrocarbons. The principles described herein, however, may alternatively be used with other types of equipment or vessels commonly lined with refractory material including, but not limited to, a thermal processing unit (e.g., fluid catalytic cracking unit or “FCCU”), a pressure vessel, a fired heater, a furnace, a conveyance pipe or line (e.g., catalyst transfer line), a fixed bed reactor, a gasifier, an incinerator, a drum, a stack, a fluid solids unit (e.g., a coker, a FLEXICOKER™ unit), an electro fluid bed, any combination thereof, or any process that uses steam or air injection for better distribution.

As illustrated, the refractory-lined equipment 100 may include a vessel 102, and a framework 104 or other type of support structure may optionally support the vessel 102. The top and bottom portions of the vessel 102 are removed (exposed) for purposes of the present description, but would otherwise be intact (included). As illustrated, the vessel 102 defines an interior 106, and all or a portion of the inner wall of the interior 106 may be lined or otherwise covered with a refractory material 108. The refractory material 108 may be anchored or otherwise secured to the inner wall via any known anchoring or attachment method. Suitable materials for the refractory material 108 include, but are not limited to, silicon carbide, magnesia, alumina, alumina graphite, magnesia graphite, high temperature porcelain, zirconia, zirconia ceramic, alumino-silicate, silica, carbon/graphite (e.g., graphite, crystalline and amorphous carbon), silicon nitride, spinel, or any combination thereof.

The refractory-lined equipment 100 may include or otherwise incorporate one or more nozzle assemblies 110 (seven shown) coupled to the outer wall of the refractory-lined equipment 100 at different points as well as at varying elevations (or distances) along a central axis of the equipment 100. While not shown in FIG. 1, in some embodiments, one or more of the nozzle assemblies 110 may be located at a lower or bottom portion of the vessel 102 and situated to discharge a fluid vertically within the vessel 102. At least a portion of each nozzle assembly 110 may penetrate the wall(s) of the vessel 102 and extend a short distance into the interior 106 to facilitate a variety of operations.

One or more of the nozzles assemblies 110 may comprise a refractory fluidization nozzle, in accordance with the present disclosure, that includes a nozzle structure including a dense outer layer and a porous inner layer, where the porous inner layer is configured to supply a fluid into the interior 106 of the vessel 102. Examples of the fluid include, but are not limited to, a gas (e.g., air, nitrogen, steam, oxygen, natural gas, and other gasses), and a liquid (e.g., hydrocarbons (crude oil, petroleum), water, and the like), or any combination thereof. Other nozzles 110 may comprise instrumentation nozzles that include a close-ended nozzle structure that houses instrumentation sensors or gauges designed to measure various operational parameters (e.g., temperature, pressure, etc.) within the interior 106, without departing from the scope of the present disclosure. Yet other types of nozzles 110 may include nozzles suitable for gas detection (e.g., NO, NOx, etc.), particulates (e.g., for opacity, etc.), without departing from the scope of the present disclosure.

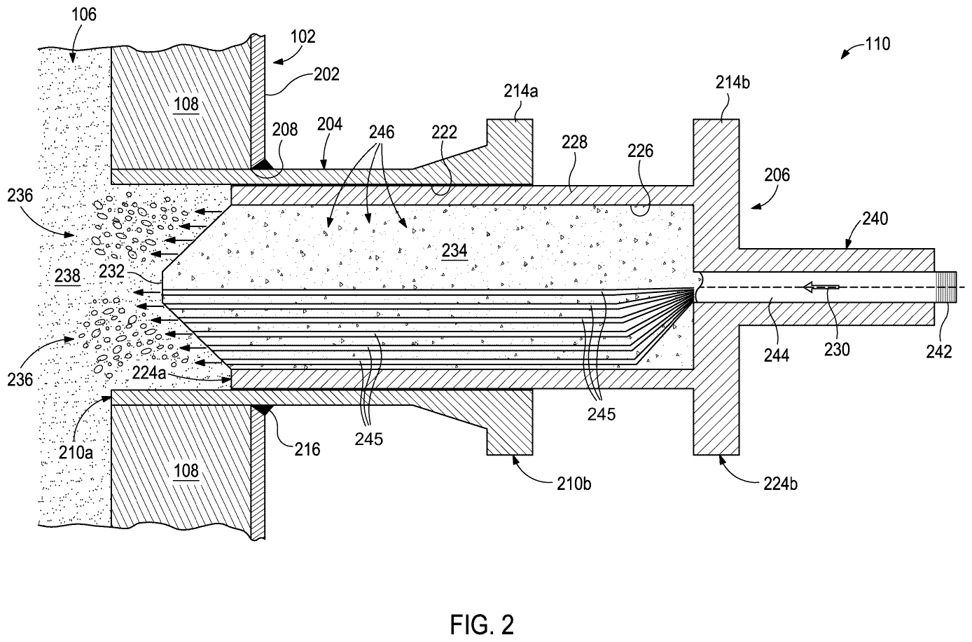

Referring now to FIG. 2, illustrated is an enlarged cross-sectional side view of an example nozzle assemblies 110, according to one or more embodiments of the present disclosure. The nozzle assembly 110 may represent any of the nozzle assemblies 110 of FIG. 1, or alternatively any nozzle assembly that may be used in conjunction with any refractory-lined equipment mentioned herein or requiring fluidization. While the nozzle assembly 110 is depicted in FIG. 2 as extending horizontally, it is also contemplated herein that the nozzle assembly 110 may be installed to extend vertically, or at any angle between horizontal and vertical.

As illustrated, the nozzle assembly 110 may include a support structure 204 (e.g., a metal sleeve, pipe, or can) and a refractory fluidization nozzle 206 may be received within the support structure 204. The support structure 204 defines an opening or central passageway 222 sized to receive the refractory fluidization nozzle 206.

As illustrated, the support structure 204 may be coupled to a sidewall 202 of the vessel 102 (see FIG. 1) and extend a short distance into the interior 106. More specifically, the support structure 204 may be received within an aperture 208 defined in the sidewall 202 of the vessel 102. In some embodiments, the support structure 204 and the aperture 208 may each exhibit a generally circular cross-section, but may alternatively exhibit other cross-sectional shapes including, but not limited to, polygonal (e.g., triangular, rectangular, pentagonal, etc.), oval, ovoid, or any combination thereof. In some embodiments, the support structure 204 may be composed of two opposing sections each anchored to opposing sides of the aperture 208 defined in the sidewall 202 of the vessel 102.

In yet other embodiments, the support structure 204 may be omitted from the nozzle assembly 110, and the refractory fluidization nozzle 206 may instead be directly received within and secured to the aperture 208. In such embodiments, the aperture 208 may be characterized as the “support structure” that receives and supports the refractory fluidization nozzle 206.

The support structure 204 may provide a first end 210a and a second end 210b opposite the first end 210a. The first end 210a may extend into the interior 106 of the vessel 102 and penetrate the refractory material 108 that lines the inner surface of the sidewall 202 of the vessel 102. In some embodiments, as illustrated, the first end 210a may terminate substantially flush with the refractory material 108. In other embodiments, however, the first end 210a may extend past the refractory material 108 or terminate at a point recessed within the depth of the refractory material 108, without departing from the scope of the present disclosure.

In some embodiments, the support structure 204 may be fixed to the sidewall 202 at the orifice 208 using one or more welds 216. The welds 216 may be applied on one or both of the inner and outer surfaces of the sidewall 202.

In some embodiments, the support structure 204 may be made of a single material (i.e., “single metallurgy”) along its axial length between the first and second ends 210a,b. In such embodiments, the support structure 204 may be made of, for example, a variety of carbon steel materials, carbon steel alloys, INCONEL® alloys, or other metals resistant to the process and capable of containing the high supply side pressure. In addition to carbon steels containing a ferritic phase, those containing austenite and/or martensite may be used as well such as, but not limited to, austenitic Types 304 and 310 and martensitic Type 410.

In other embodiments, however, the support structure 204 may be made of at least two materials (i.e., “dual metallurgy”) along its axial length. In such embodiments, the support structure 204 may include a first portion that extends to the first end 210a and a second portion that extends to the second end 210b and is joined to the first portion at a weld seam (not shown). In such embodiments, the first portion will be exposed to the environment within the interior 106 of the vessel 102, and may thus be made of materials exhibiting elevated resistance to corrosion, erosion, abrasion, etc. Suitable materials for the first portion include, but are not limited to, any of the carbon steel alloys mentioned herein. The second portion, however, may extend outside of the vessel 102 and may thus be made of less robust materials such as carbon steel. In at least one embodiment, the second portion may be made of the same as the sidewall 202, thus eliminating the need to make a bi-metallic weld at the welds 216.

In some embodiments, the refractory fluidization nozzle 206 may be permanently secured to the support structure 204 within the central passageway 222. In such embodiments, the support structure 204 may surround the refractory fluidization nozzle 206 and form an interference fit that prevents the refractory fluidization nozzle 206 from escaping the central passageway 222. In other embodiments, however, the refractory fluidization nozzle 206 may be able to be removed from the support structure 204 to enable a worker to disengage and retract the nozzle assembly 206 from the outer sleeve 204 external to the vessel 102. In such embodiments, the second end 210b of the support structure 204 may provide or otherwise define a first flange 214a configured to be secured to a second flange 214b provided by the refractory fluidization nozzle 206. The flanges 214a,b could be secured together via a bolted flange connection, for example, but could alternatively provide a removable bayonet attachment or configuration, without departing from the scope of the disclosure.

The refractory fluidization nozzle 206 may include a first end 224a and a second end 224b opposite the first end 224a. In some embodiments, the first end 224a may be designed to extend into the interior 106 of the vessel 102 via the central passageway 222. In such embodiments, the first end 224a may protrude or otherwise extend past the first end 210a of the support structure 204. In other embodiments, however, the first end 224a may terminate substantially flush with the first end 210a of the support structure 204, or may alternatively terminate at a point recessed into the support structure 204 and the surrounding refractory material 108, without departing from the scope of the disclosure.

As illustrated, the refractory fluidization nozzle 206 may include a dense outer layer 228 that surrounds or encases a porous inner layer 234. More specifically, the dense outer layer 228 may define an interior flow passage 226 and the porous inner layer 234 may be positioned within the interior flow passage 226. In some embodiments, as illustrated, an end 232 of the porous inner layer 234 may extend past the end of the dense outer layer 228, and may otherwise protrude out of the interior flow passage 226. In other embodiments, however, the end 232 of the porous inner layer 234 may terminate substantially flush with the end of the dense outer layer 228, or may alternatively terminate at some point recessed into the interior flow passage 226, without departing from the scope of the disclosure. In some embodiments, the end 232 of the porous inner layer 234 may be angled and otherwise define one or more angled surfaces.

In some embodiments, as illustrated, the dense outer layer 228 provides and otherwise defines an injection inlet (or nipple) 240 in fluid communication with the interior flow passage 226. A fluid 230 (i.e., a gas and/or a liquid) may be conveyed into the interior flow passage 226, and therefore into the porous inner layer 234, via the injection inlet 240. As described herein, the fluid 230 may be used to fluidize particulates within the interior 106 of the vessel 102 during an oil and gas process.

As illustrated, the injection inlet 240 provides a connection 242 that provides a location to fluidly couple the refractory fluidization nozzle 206 to a pressurized source of the fluid 230. As described herein, the fluid 230 is conveyed into and through the porous inner layer 234 of the refractory fluidization nozzle 206. In at least one embodiment, the refractory fluidization nozzle 206 may be operatively coupled to a gas header (not shown) at the connection 242, and the header may be supplied with the fluid 230 for distribution to the refractory fluidization nozzle 206 and one or more additional nozzles arranged in series with the refractory fluidization nozzle 206.

The injection inlet 240 provides or defines a conduit 244 through which the fluid 230 may be conveyed to be introduced into the porous inner layer 234. In some embodiments, the conduit 244 may comprise an open-air or unobstructed conduit, such as a pipe. In other embodiments, however, the conduit 244 may be at least partially filled with a portion or extension of the porous inner layer 234, thus situating some of the material of the porous inner layer 234 within at least a portion of the conduit 244.

The dense outer layer 228 and the porous inner layer 234 may each be composed of a refractory or ceramic material. The base refractory material for the dense outer layer 228 and the porous inner layer 234 may be the same or of a different composition. Suitable refractory materials for the dense outer layer 228 and the porous inner layer 234 include, but are not limited to, any of the refractory materials described herein, including oxides, carbides, and nitrides with other elements, such as, but not limited to, silicon, aluminum, magnesium, calcium, boron, chromium, and zirconium. Specific examples of suitable refractory materials for the dense outer layer 228 and the porous inner layer 234 include, but are not limited to, alumina (Al₂O₃), zirconia (ZrO₂), silica (Si₂O), chromic (Cr₂O₃), magnesia (Mg), silicon carbide (Sic), silicon nitride (Si₃N₄), carbon graphite, and the like, and any combination thereof. Such refractory materials provide thermal insulation at high temperature (i.e., temperatures in which oil and gas processes may be performed, such as up to or greater than 500° C.), corrosion resistance, and erosion resistance. In some embodiments, the material for the porous inner layer 234 may comprise a porous metal, a porous ceramic/refractory, a slotted metal, a slotted ceramic/refractory, or any combination thereof.

In one or more embodiments, the refractory materials for forming the dense outer layer 228 may comprise a plurality of high-temperature refractory castables or shaped (pressed or co-pressed) refractories, wherein the porous inner layer 234 is secured to the inner surface of the dense outer layer 228 or otherwise compressed by the dense outer layer 228 to form an interference fit. In yet other embodiments, the refractory materials for forming the dense outer layer 228 and the porous inner layer 234 may comprise a ceramic, an engineered ceramic, a ceramic fiber product, a refractory plastic, or any combination thereof. Moreover, the refractory material(s) forming the dense outer layer 228 and the porous inner layer 234 may advantageously be prefabricated, cured (dried), and fired prior to installation, thus eliminating the need to cure and fire the refractory material in situ and, further, advantageously removing moisture and enhancing bond formation between the dense outer layer 228 and the porous inner layer 234.

As provided above, the dense outer layer 228 encases the porous inner layer 234 and is composed of a refractory material that does not permit diffusion of fluids (e.g., the fluid 230) therethrough. Accordingly, the dense outer layer 228 may be composed of a refractory material that is substantially or entirely impermeable to fluids injected through the refractory fluidization nozzle 206. In contrast, the porous inner layer 234 is composed of a porous refractory material and otherwise a material that permits diffusion of the fluid 230 therethrough. That is, the porous inner layer 234 is composed of a permeable refractory material.

Circulating the fluid 230 through the refractory fluidization nozzle 206 and, more particularly, through the porous inner layer 234, may result in bubbles 236 being discharged at the first end 224a of the refractory fluidization nozzle 206. In some applications, the bubbles 236 discharged from the porous inner layer 234 may diffuse directly into a bed of particles 238 present within the interior 106 of the vessel 102. The diffusing bubbles 236 help fluidize the bed of particles 238 by decreasing the density of the solid particulates that form the bed of particles 238, which results in the particulates acting like a fluid. In such embodiments, the vessel 102 may form part of a fluidized catalytic cracking unit (FCCU) for cracking heavy oil into various fractions.

In particular embodiments, the material and design of the porous inner layer 234 may be engineered to control the particle size of the resultant bubbles 236 exiting the porous inner layer 234 at or near the first end 224a. In at least one embodiment, for example, the average diameter of the bubbles 236 discharged from the porous inner layer 234 may be in the range of about 10 μm to about 100 μm, and encompassing any value and subset therebetween.

In some embodiments, the porous inner layer 234 may be permeable by engineering the material of the porous inner layer 234 to include or otherwise define a plurality of directionally-slotted channels 245 extending longitudinally through the porous inner layer 234 and between opposing ends thereof. As illustrated, each channel 245 may be in fluid communication with the conduit 244 such that fluids 230 introduced into the conduit 244 will be able to be fed into the channels 245, circulate through the channels 245, and eventually be discharged from the channels 245 as bubbles 236 that diffuse into the adjacent bed of particles 236 for fluidization.

In some embodiments, one or more of the channels 245 may exhibit a round or circular cross-section. In such embodiments, the size or diameter of the channels 245 may be about 1 mm, but could alternatively exhibit other sizes or diameters, without departing from the scope of the disclosure. In embodiments where the diameter of the channels 245 is about 1 mm, the porous inner layer 234 may include approximately 100 channels 245, which may be about equal to the nominal area of a traditional flow path 236 orifice. In other embodiments, however, one or more of the channels 245 may exhibit a polygonal cross-section, such as square or rectangular. In such embodiments, one or more of the channels 245 may exhibit a width that is larger than its height, and may thus be considered longitudinally-extending slots. Moreover, in such embodiments, the width of the channels 245 may be about 0.5 mm and the length may be about 25 mm. In such embodiments, the porous inner layer 234 may include approximately 12 to 24 channels 240, which may be about equal to the nominal area of a traditional flow path 236 orifice. In some embodiments, two or more of the channels 245 may be parallel to one another.

The channels 245 may be defined in the porous inner layer 234 by any known manufacturing or forming technology. In at least one application, for example, while forming the porous inner layer 234, burnout materials may be selectively positioned at desired locations for the channels 245 in the pre-solidified refractory material of the porous inner layer 234. Upon curing and firing the refractory material, the burnout materials will be consumed, and the longitudinally-extending channels 245 will remain within the cured refractory material.

In some embodiments, the porous inner layer 234 may be permeable by engineering the material to include a multitude of interstitial spaces and pores 246 that provide an interconnected network of tight conduits and passages extending between opposing ends of the porous inner layer 234. In such embodiments, the porous inner layer 234 will be in fluid communication with the conduit 244 such that the fluid 230 introduced into the conduit 244 will be fed into the tortuous network of the interstitial spaces and pores 246 and flow (circulate) to the opposing end where it will eventually be discharged as bubbles 236 that diffuse into the adjacent bed of particles 236 for fluidization.

The interstitial spaces and pores 246 may be defined in the porous inner layer 234 by any known manufacturing or forming technology. In at least one application, for example, the pre-solidified refractory material of the porous inner layer 234 may be formed around and through a porous foam or other consumable material. Upon firing and curing the refractory material, the porous foam or other consumable material will be consumed, and the interstitial spaces and pores 246 will remain within the cured refractory material.

FIG. 2 depicts the porous inner layer 234 as including both directionally-slotted channels 245 and the interstitial spaces and pores 246, which may be consistent with at least one embodiment of the present disclosure. In other embodiments, however, the porous inner layer 234 may include only directionally-slotted channels 245 or alternatively only the interstitial spaces and pores 246.

The geometry and configuration of the porous inner layer 234 may be such that if the flow of the fluid 230 ceases, any fluidized particles in the bed of particles 236 will be prevented from migrating into the porous inner layer 234, such as into the channels 245 or into the interstitial spaces and pores 246. In other words, the particles in the bed of particles 236 may be larger than any holes or apertures in the porous inner layer 234, which may prove advantageous in preventing the particles from entering and solidifying within the body of the porous inner layer 234.

Unless otherwise indicated, all numbers expressing quantities of ingredients, properties such as molecular weight, reaction conditions, and so forth used in the present specification and associated claims are to be understood as being modified in all instances by the term “about.” Accordingly, unless indicated to the contrary, the numerical parameters set forth in the following specification and attached claims are approximations that may vary depending upon the desired properties sought to be obtained by the incarnations of the present inventions. At the very least, and not as an attempt to limit the application of the doctrine of equivalents to the scope of the claim, each numerical parameter should at least be construed in light of the number of reported significant digits and by applying ordinary rounding techniques.

One or more illustrative incarnations incorporating one or more invention elements are presented herein. Not all features of a physical implementation are described or shown in this application for the sake of clarity. It is understood that in the development of a physical embodiment incorporating one or more elements of the present invention, numerous implementation-specific decisions must be made to achieve the developer's goals, such as compliance with system-related, business-related, government-related and other constraints, which vary by implementation and from time to time. While a developer's efforts might be time-consuming, such efforts would be, nevertheless, a routine undertaking for those of ordinary skill in the art and having benefit of this disclosure.

While compositions and methods are described herein in terms of “comprising” various components or steps, the compositions and methods can also “consist essentially of” or “consist of” the various components and steps.

### Additional Embodiments

The present disclosure provides, among others, the following examples, each of which may be considered as optionally including any alternate example.

Clause 1: A refractory-lined equipment includes a vessel that defines an interior and houses a bed of particles, a refractory material secured to an inner wall of the interior, a nozzle assembly coupled to and penetrating a sidewall of the vessel and extending into the interior, the nozzle assembly including, a support structure, and a refractory fluidization nozzle received within the support structure and including a dense outer layer that defines an interior flow passage, and a porous inner layer positioned within the interior flow passage. The equipment further includes a fluid circulated through the porous inner layer and discharged into the vessel as bubbles that fluidize the bed of particles, wherein the dense outer layer is composed of a refractory material that is impermeable to the fluid, and the porous inner layer is composed of a refractory material that is permeable to the fluid.

Clause 2: The refractory-lined equipment of Clause 1, wherein the vessel is selected from the group consisting of a reactor vessel, a thermal processing unit, a pressure vessel, a fired heater, a furnace, a conveyance pipe or line, a fixed bed reactor, a gasifier, an incinerator, a drum, a stack, a fluid solids unit, and any combination thereof.

Clause 3: The refractory-lined equipment of Clause 1, wherein the support structure is receivable within an aperture defined in the sidewall and attached to the sidewall at the aperture.

Clause 4: The refractory-lined equipment of Clause 3, wherein the support structure comprises a metal sleeve, pipe, or can.

Clause 5: The refractory-lined equipment of Clause 1, wherein the support structure comprises an aperture defined in the sidewall and the refractory fluidization nozzle is received within and secured to the aperture.

Clause 6: The refractory-lined equipment of Clause 1, wherein the dense outer layer provides an injection inlet in fluid communication with the interior flow passage and through which the fluid is conveyed into the porous inner layer.

Clause 7: The refractory-lined equipment of Clause 1, wherein the bubbles exiting the porous inner layer exhibit an average diameter ranging between about 10 μm and about 1000 μm.

Clause 8: The refractory-lined equipment of Clause 1, wherein one or more directionally-slotted channels are defined through the porous inner layer.

Clause 9: The refractory-lined equipment of Clause 1, wherein a multitude of interstitial spaces and pores are defined in the porous inner layer to provide an interconnected network of conduits and passages through which the fluid flows.

Clause 10: A method includes providing a vessel that defines an interior and houses a bed of particles and includes a refractory material secured to an inner wall of the interior, and a nozzle assembly coupled to and penetrating a sidewall of the vessel and extending into the interior, the nozzle assembly including a support structure, and a refractory fluidization nozzle received within the support structure and including a dense outer layer that defines an interior flow passage, and a porous inner layer positioned within the interior flow passage. The method further includes circulating a fluid through the porous inner layer and discharging the fluid from the porous inner layer and into the interior as bubbles, and fluidizing the bed of particles with the bubbles, wherein the dense outer layer is composed of a refractory material that is impermeable to the fluid, and the porous inner layer is composed of a refractory material that is permeable to the fluid.

Clause 11: The method of Clause 10, wherein the dense outer layer provides an injection inlet in fluid communication with the interior flow passage, the method further comprising conveying the fluid into the porous inner layer via the injection inlet.

Clause 12: The method of Clause 10, further comprising discharging the bubbles from the porous inner layer with an average diameter ranging between about 10 μm and about 1000 μm.

Clause 13: The method of Clause 10, wherein one or more directionally-slotted channels are defined through the porous inner layer, and wherein circulating the fluid through the porous inner layer comprises circulating the fluid through the one or more directionally-slotted channels.

Clause 14: The method of Clause 10, wherein a multitude of interstitial spaces and pores are defined in the porous inner layer, and wherein circulating the fluid through the porous inner layer comprises circulating the fluid through the multitude of interstitial spaces and pores.

Clause 15: A nozzle assembly for fluidizing solid particulates includes a support structure, and a refractory fluidization nozzle received within the support structure and including a dense outer layer that defines an interior flow passage, and a porous inner layer positioned within the interior flow passage, wherein the dense outer layer is composed of a refractory material that is impermeable to fluids, and the porous inner layer is composed of a refractory material that is permeable to fluids.

Clause 16: The nozzle assembly of Clause 15, wherein the support structure comprises a metal sleeve, pipe, or can.

Clause 17: The nozzle assembly of Clause 16, wherein the refractory fluidization nozzle is secured to the support structure via a bolted flange connection.

Clause 18: The nozzle assembly of Clause 16, wherein the refractory fluidization nozzle is received within the support structure via an interference fit.

Clause 19: The nozzle assembly of Clause 15, wherein the dense outer layer provides an injection inlet in fluid communication with the interior flow passage and through with the fluid may be conveyed into the porous inner layer.

Clause 20: The nozzle assembly of Clause 15, wherein one or more directionally-slotted channels are defined through the porous inner layer.

Clause 21: The refractory-lined equipment of Clause 15, wherein a multitude of interstitial spaces and pores are defined in the porous inner layer to provide an interconnected network of conduits and passages through which the fluid flows.

Therefore, the present invention is well adapted to attain the ends and advantages mentioned as well as those that are inherent therein. The particular examples and configurations disclosed above are illustrative only, as the present invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative examples disclosed above may be altered, combined, or modified and all such variations are considered within the scope and spirit of the present invention. The invention illustratively disclosed herein suitably may be practiced in the absence of any element that is not specifically disclosed herein and/or any optional element disclosed herein. While compositions and methods are described in terms of “comprising,” “containing,” or “including” various components or steps, the compositions and methods can also “consist essentially of” or “consist of” the various components and steps. All numbers and ranges disclosed above may vary by some amount. Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an,” as used in the claims, are defined herein to mean one or more than one of the element that it introduces.

1-13. (canceled)

14. A refractory-lined equipment, comprising:
a vessel that defines an interior and houses a bed of particles;
a refractory material secured to an inner wall of the interior;
a nozzle assembly coupled to and penetrating a sidewall of the vessel and extending into the interior, the nozzle assembly including:
a support structure; and
a refractory fluidization nozzle received within the support structure and including a dense outer layer that defines an interior flow passage, and a porous inner layer positioned within the interior flow passage; and
a fluid circulated through the porous inner layer and discharged into the vessel as bubbles that fluidize the bed of particles,
wherein the dense outer layer is composed of a refractory material that is impermeable to the fluid, and the porous inner layer is composed of a refractory material that is permeable to the fluid.

15. The refractory-lined equipment of claim 14, wherein the vessel is selected from the group consisting of a reactor vessel, a thermal processing unit, a pressure vessel, a fired heater, a furnace, a conveyance pipe or line, a fixed bed reactor, a gasifier, an incinerator, a drum, a stack, a fluid solids unit, and any combination thereof.

16. The refractory-lined equipment of claim 14, wherein the support structure is receivable within an aperture defined in the sidewall and attached to the sidewall at the aperture.

17. The refractory-lined equipment of claim 16, wherein the support structure comprises a metal sleeve, pipe, or can.

18. The refractory-lined equipment of claim 14, wherein the support structure comprises an aperture defined in the sidewall and the refractory fluidization nozzle is received within and secured to the aperture.

19. The refractory-lined equipment of claim 14, wherein the dense outer layer provides an injection inlet in fluid communication with the interior flow passage and through which the fluid is conveyed into the porous inner layer.

20. The refractory-lined equipment of claim 14, wherein the bubbles exiting the porous inner layer exhibit an average diameter ranging between about 10 μm and about 1000 μm.

21. The refractory-lined equipment of claim 14, wherein one or more directionally-slotted channels are defined through the porous inner layer.

22. The refractory-lined equipment of claim 14, wherein a multitude of interstitial spaces and pores are defined in the porous inner layer to provide an interconnected network of conduits and passages through which the fluid flows.

23. A method, comprising:
providing a vessel that defines an interior and houses a bed of particles and includes a refractory material secured to an inner wall of the interior, and a nozzle assembly coupled to and penetrating a sidewall of the vessel and extending into the interior, the nozzle assembly including:
a support structure; and
a refractory fluidization nozzle received within the support structure and including a dense outer layer that defines an interior flow passage, and a porous inner layer positioned within the interior flow passage;
circulating a fluid through the porous inner layer and discharging the fluid from the porous inner layer and into the interior as bubbles; and
fluidizing the bed of particles with the bubbles,
wherein the dense outer layer is composed of a refractory material that is impermeable to the fluid, and the porous inner layer is composed of a refractory material that is permeable to the fluid.

24. The method of claim 23, wherein the dense outer layer provides an injection inlet in fluid communication with the interior flow passage, the method further comprising conveying the fluid into the porous inner layer via the injection inlet.

25. The method of claim 23, further comprising discharging the bubbles from the porous inner layer with an average diameter ranging between about 10 μm and about 1000 μm.

26. The method of claim 23, wherein one or more directionally-slotted channels are defined through the porous inner layer, and wherein circulating the fluid through the porous inner layer comprises circulating the fluid through the one or more directionally-slotted channels.

27. The method of claim 23, wherein a multitude of interstitial spaces and pores are defined in the porous inner layer, and wherein circulating the fluid through the porous inner layer comprises circulating the fluid through the multitude of interstitial spaces and pores.

28. A nozzle assembly for fluidizing solid particulates, comprising:
a support structure; and
a refractory fluidization nozzle received within the support structure and including a dense outer layer that defines an interior flow passage, and a porous inner layer positioned within the interior flow passage,
wherein the dense outer layer is composed of a refractory material that is impermeable to fluids, and the porous inner layer is composed of a refractory material that is permeable to fluids.

29. The nozzle assembly of claim 28, wherein the support structure comprises a metal sleeve, pipe, or can.

30. The nozzle assembly of claim 29, wherein the refractory fluidization nozzle is secured to the support structure via either a bolted flange connection or an interference fit.

31. The nozzle assembly of claim 28, wherein the dense outer layer provides an injection inlet in fluid communication with the interior flow passage and through with the fluid may be conveyed into the porous inner layer.

32. The nozzle assembly of claim 28, wherein one or more directionally-slotted channels are defined through the porous inner layer.

33. The refractory-lined equipment of claim 28, wherein a multitude of interstitial spaces and pores are defined in the porous inner layer to provide an interconnected network of conduits and passages through which the fluid flows.
